(19) United States
(12) Patent Application Publication
(10) Pub. No.: US 2005/0237711 A1
(43) Pub. Date: Oct. 27, 2005

(54) Spoiler sandwiched between a hard disk and a cooling fan

(76) Inventor: Han Liu, Fremont, CA (US)

Correspondence Address: DELLETT AND WALTERS, P. O. BOX 2786, PORTLAND, OR, 97208-2786, US

(21) Appl. No.: 10/831,676

(22) Filed: Apr. 23, 2004

(51) Int. Cl. G06F 1/20

(52) U.S. Cl. 361/687; 361/685

(57) ABSTRACT

A spoiler adapted to be sandwiched between a hard disk and a cooling fan includes a body with a front face and a rear face. The front face is able to penetrate airflow moving directly towards a side wall of the hard disk and a rear face adapted to securely engage with the side wall of the hard disk such that noise generated by airflow moving to the hard disk is reduced.

### BACKGROUND OF THE INVENTION

1. Field of the Invention

The present invention relates to a spoiler, and more particularly to a spoiler sandwiched between a hard disk and a cooling fan to reduce noise generated by airflow passing over the hard disk.

2. Description of Related Art

A computer normally generates noise when a cooling fan is blowing air around the hard disk in the computer. With reference to FIG. 3, it is noted that when multiple hard disks (30) are superposed and spaced apart from each other in the computer to increase not only the memory capability, but also the operation speed, noise is generated by airflow passing through the gaps (32) between two adjacent hard disks (30).

When a cooling fan (31) located to the side of the hard disks (30) is blowing air through the gaps (32), the air flowing through the gaps (32) will remove the heat generated by the hard disks (30). However, the airflow impacting the side walls of the hard disks (30) generates annoying noise. The noise becomes louder as the fan rotates quicker. The airflow directly impacting the side walls of the hard disks (30) generates turbulence which is the source of the noise, so that the thicker the hard disk (30) is, the louder the noise is. The turbulence also decreases the airflow passing through the gaps between hard drives.

The present invention overcomes the abovementioned shortcomings.

### SUMMARY OF THE INVENTION

The primary objective of the invention is to reduce the noise generated by the airflow and to increase the cooling effect of the fan.

In order to accomplish said objective, the spoiler of the invention has a body with a curved front face facing the cooling fan and a flat rear face securely attached to a side wall of the hard disk. The airflow, instead of creating turbulence by hitting the side of the hard disk, is split and directed above and below the hard disk, thus reducing the noise.

Other objects, advantages and novel features of the invention will become more apparent from the following detailed description when taken in conjunction with the accompanying drawings.

### BRIEF DESCRIPTION OF THE DRAWINGS

FIG. 1 is a perspective view showing the spoiler of the present invention;

FIG. 2 is a schematic side plan view showing the application of multiple spoilers attached to front side faces of hard disks; and

FIG. 3 is a schematic side plan view showing the turbulence generation in a combination of conventional hard disks and a cooling fan.

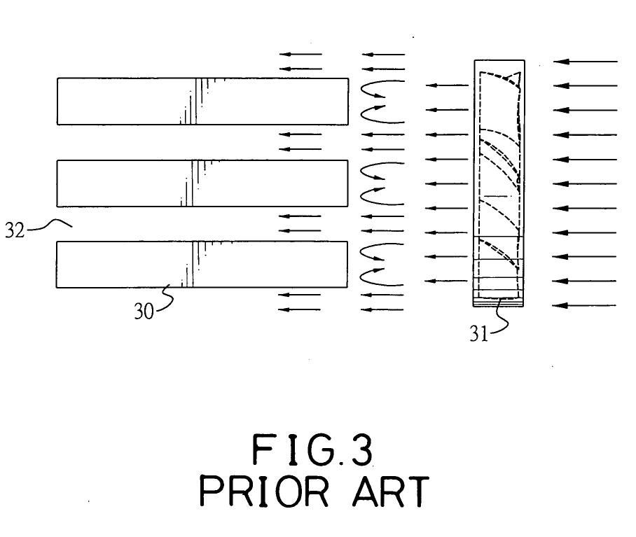

### DETAILED DESCRIPTION OF THE PREFERRED EMBODIMENT

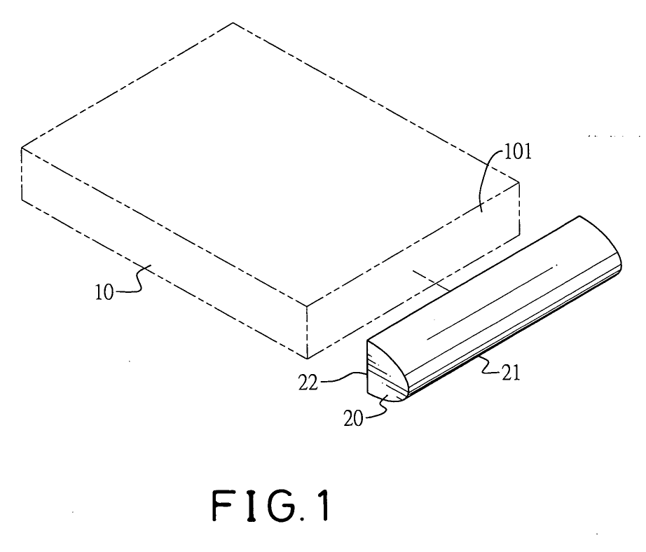

With reference to FIG. 1, the spoiler constructed in accordance with the present invention has a body (20), a curved front face (21) and a flat rear side face (22) facing a side wall (101) of a hard disk (10). The front face (21) in this embodiment is curved but it may be in the shape of a pyramid and still perform its task.

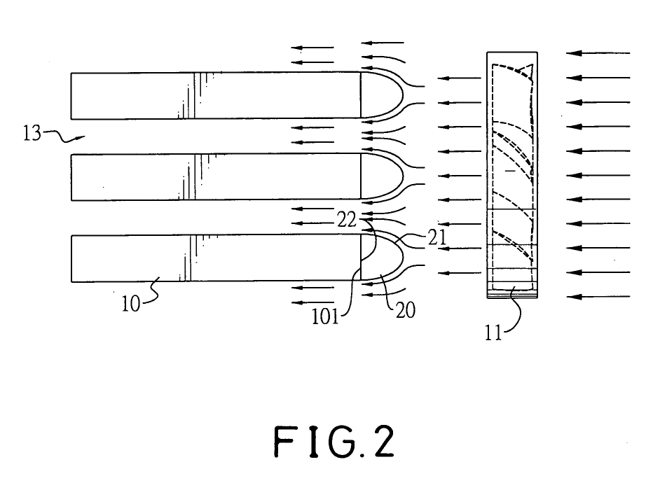

With reference to FIG. 2, it is noted that a cooling fan (11) is blowing air to the hard disks (10) on top of one another and defining therebetween air paths (13). When airflow passes into the air paths (13), heat generated by hard disks (10) will be removed by the airflow. Also, the curved front face (21) of the spoiler (20) of the present invention easily penetrates the airflow moving directly toward the hard disks (10) and thus the noise generated by turbulence is reduced. Since more air is actually passing by the hard disk now, the cooling efficiency is increased, and a slower fan can be used instead, further reducing the noise.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A spoiler adapted to be sandwiched between a hard disk and a cooling fan, the spoiler comprising:
a body having a front face adapted to face toward the cooling fan and a flat rear face adapted to securely engage with a side wall of the hard disk such that noise generated by airflow moving directly to the side wall of the hard disk is reduced.

2. A spoiler adapted to be sandwiched between a hard disk and a cooling fan, the spoiler comprising:
a body having a pyramidal front face adapted to face toward the cooling fan and a flat rear face adapted to securely engage with a side wall of the hard disk such that noise generated by airflow moving directly to the side wall of the hard disk is reduced.
